(19) United States
(12) Patent Application Publication
(10) Pub. No.: US 2011/0179708 A1
(43) Pub. Date: Jul. 28, 2011

(54) Multiple Self-Watering Container System

(76) Inventor: Donald J. Stewart, Merced, CA (US)

(21) Appl. No.: 12/691,916

(22) Filed: Jan. 22, 2010

(51) Int. Cl. A01G 9/02

(52) U.S. Cl. 47/65.9; 47/81; 47/66.7

(57) ABSTRACT

A multiple plant container self-watering system is disclosed which through use of an adjustable wicking system maintains for a plurality of plants a uniform water draw rate despite varying water depths among containers. The invention comprises a primary container and a plurality of secondary containers in fluid relation with one another such that when water is supplied to one container it flows through to all other containers. Gravity ensures water depth remains constant among containers on flat ground, but to offset differences in depth caused by elevational differences among containers, a wick elevator is provided so the wick may be vertically adjusted to the water level.

### FIELD OF INVENTION

This invention relates to a multiple plant container self-watering system, wherein the plants draw water from an adjustable wicking system that maintains a uniform water supply to said plants despite varying water depths among said containers.

### BACKGROUND OF INVENTION

Self-watering systems for plants are known in the art. For example, U.S. Pat. No. 6,497,071 to Main et al., and U.S. Pat. No. 5,369,910 to Copenhaver disclose watering systems which relate to Christmas trees; while U.S. Pat. No. 6,357,179 to Buss, U.S. Pat. No. 6,079,156 to Colovic, and U.S. Pat. No. 5,020,261 to Lishman are typical examples of the prior art that relate to the self watering of plants and planters. The prior art self-watering systems are frequently expensive to purchase, complicated to implement, and burdensome to adjust and maintain. Moreover, for purposes of the present invention, the prior art self watering systems are difficult to adjust to accommodate different numbers of plants or containers and in particular when said numbers of plants or containers are not on even ground or when there are otherwise elevational differences between multiple plants in a system. In such instances, the prior art generally requires such a self watering system to comprise multiple individual systems for each plant or container to be supplied water.

In still other multiple watering systems, such as multiple plant drip systems, each plant generally receives an equal amount of water. Drip systems have developed means to vary the flow rate at each particular drip point; however, they are not very precise.

In theory one can ideally vary the flow rate of each particular drip point such that when the system is activated each container is watered until the soil is saturated (generally indicated by water running out the bottom). The soil is then allowed to dry down, and the water cycle is repeated before the plant experiences any stress due to a lack of water. In practice though, the flow rate emitters are not particularly precise (for instance, ½ gph, 1 gph and 2 gph emitters are common), and so are better suited to large areas like beds where the large amount of soil acts as a reservoir and water storage buffer.

Common drawbacks to drip systems include overly saturated soil, drainage through the bottom of the pot, and underwatering. Overwatering and underwatering can occur where the drip system is not tuned exactly to the needs of each plant. Draining through the bottom of the pot is wasteful and can be a nuisance, such as when water drains from the deck of an upper apartment to an apartment below. To remedy this the pot is often placed in a dish, which has its own downsides in that it can lead to root problems due to water accumulating in the dish. Because the needs of the plant can vary with season, temperature, amount of sunlight, and size of the plant, avoiding these drawbacks can be difficult.

U.S. Pat. Pub. 2009-0277085 A1, filed by the present Applicant described a multi-container system comprising a plurality of containers in fluid connection with one another such that the containers may be installed and watered daisy chain style as space limitations permit or as may be desired by the owner or caretaker. The Applicant's previous system was capable of being adjusted to provide a constant water supply to all plants in the system regardless of the water uptake rate of any given plant in the system. Although it did provide the owner the ease of watering all plants through the installation of a self-watering system installed to just one of the containers, it suffered from the drawback that where there was an elevation change between or among containers, water would more readily flow to the lower containers at the detriment to those on higher ground. Consequently, certain plants (whose containers were at lower elevation) were overwatered while certain other plants (whose containers were at higher elevation) were underwatered.

### SUMMARY OF THE INVENTION

The present invention relates to a multiple plant container self-watering system, wherein the plants draw water from an adjustable wicking system that maintains a uniform water draw rate despite varying water depths among containers. The wicking system also provides a means to vary the liquid draw rate at which individual plants in the system draw water.

To accomplish the above, the invention comprises a multi-container system wherein a first container comprises a water retaining chamber and water transfer and self water leveling means, a water input, a fluid linkage to a second container, a water wicking means to transfer water to the plants, a wick level adjustment means, a plant support structure, a soil barrier, a plant enclosure, and a water level gage. The second container in the system comprises a water transfer and retaining chamber, a fluid linkage to the first container, a water wicking means, a wick level adjustment means, a plant support structure, a soil barrier, and a plant enclosure. The second container is in fluid connection to the first container and the water level is shared between containers. A plurality of additional containers similar to the second container may be fluidly connected to the first container, second container, or one another daisy chain style as space limitations permit, or as may be desired by the user. Although in the preferred embodiment only the first container is described to comprise a water input, in optional embodiments all containers may comprise the water input or in an embodiment where a user manually adds water to the system, none of the containers may have a water input.

The benefits of the present invention are that the water in the system remains equally accessible to all plants regardless of incline or elevation change between or among containers. Further, because of the nature of the water wicking aspect of the system, plants that require differing amounts of water may all be maintained within a single system. The individual plants are provided adequate water from which they may draw according to their individual needs, and as a result there is no need to adjust the flow of water to each plant. Further, the device is of low cost and expandable to suit the owner's desires or the physical space available, and is easily transportable from location to location should the owner move. Further, the invention may be utilized with or without a timer, and with a finite amount water source such as a barrel, or with a controlled but unlimited amount source such as a hose.

It is a first objective of the present invention to provide an improved multi-container self-watering system that accommodates plant containers located at non-uniform elevations;

It is a further objective of the present invention to provide a low cost, easy to use, highly efficient, self watering container system.

It is a still further objective of the present invention to provide a container system that can be expanded to any number of containers limited only by water input capability and available space.

It is a still further objective of the present invention to provide a self-watering system that employs capillary action via a wicking system and maintains separation between the watering system and the soil, thus minimizing cleaning and upkeep requirements.

It is a still further objective of the present invention to provide a self-watering multi-container system that may employ different sized containers.

It is a still further objective of the present invention to provide a self-watering system that achieves an even distribution of water throughout the entire growing medium despite different elevations between containers.

It is a still further objective of the present invention to provide a self-watering system that allows a user to provide different levels of moisture to different containers while utilizing only a single self-watering system.

It is a still further objective of the present invention to provide a self-watering system that gives the user control over the moisture content available to the plants in each individual container.

These and other objects, advantages, features and aspects of the present invention will become apparent as the following description proceeds. To the accomplishment of the foregoing and related ends, the invention, then, comprises the features hereinafter more fully described and particularly pointed out in the claims, the following description and the annexed drawings setting forth in detail certain illustrative embodiments of the invention, these being indicative, however, of but several of the various ways in which the principles of the invention may be employed.

### BRIEF DESCRIPTION OF THE DRAWINGS

In the annexed drawings:

FIG. 1 is cutaway cross-sectional view of a multiple container plant watering system according to a preferred embodiment of the invention;

FIG. 2 is a front top perspective view of the first and second containers fluidly connected together;

FIG. 3 is a cutaway front perspective view of the first container according to the preferred embodiment of the invention;

FIG. 4 is a top perspective view of the first container according to the preferred embodiment of the invention wherein elements have been removed for purposes of clarity;

FIG. 5 is a top perspective view of the first container according to the preferred embodiment of the invention, wherein cutline 7-7 is drawn;

FIG. 6 is an perspective exploded view of the various components of the invention according to the preferred embodiment;

FIG. 7 is a cross-sectional view of the fully assembled apparatus taken along cutline 7-7 in FIG. 5;

FIG. 8 is a detailed depiction of the wick elevator; and

FIG. 9 is a cross-sectional view of the fully assembled apparatus according to an alternative embodiment of the invention, and corresponding to FIG. 7 and cutline 7-7 in FIG. 5.

### DETAILED DESCRIPTION OF THE INVENTION

The following description is presented to enable a person of ordinary skill in the art to make and use various aspects and examples of the present invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

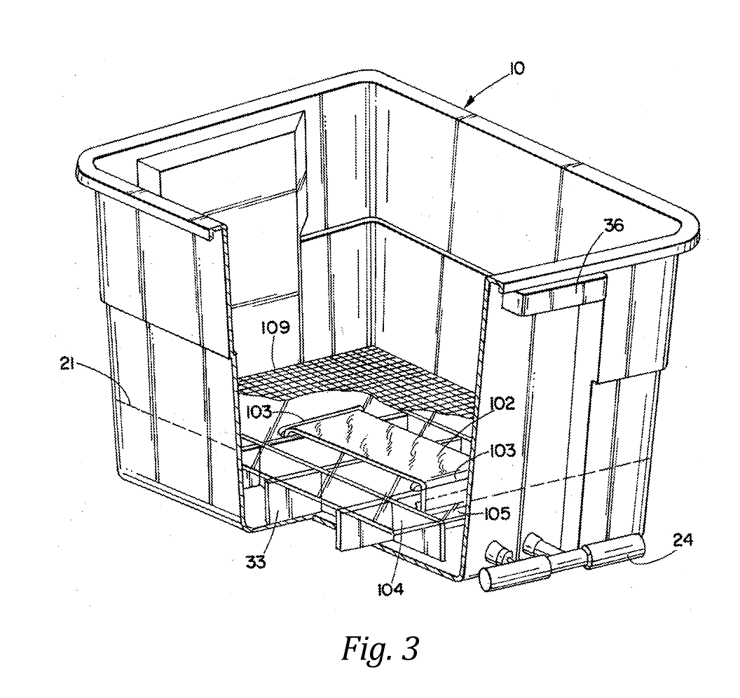

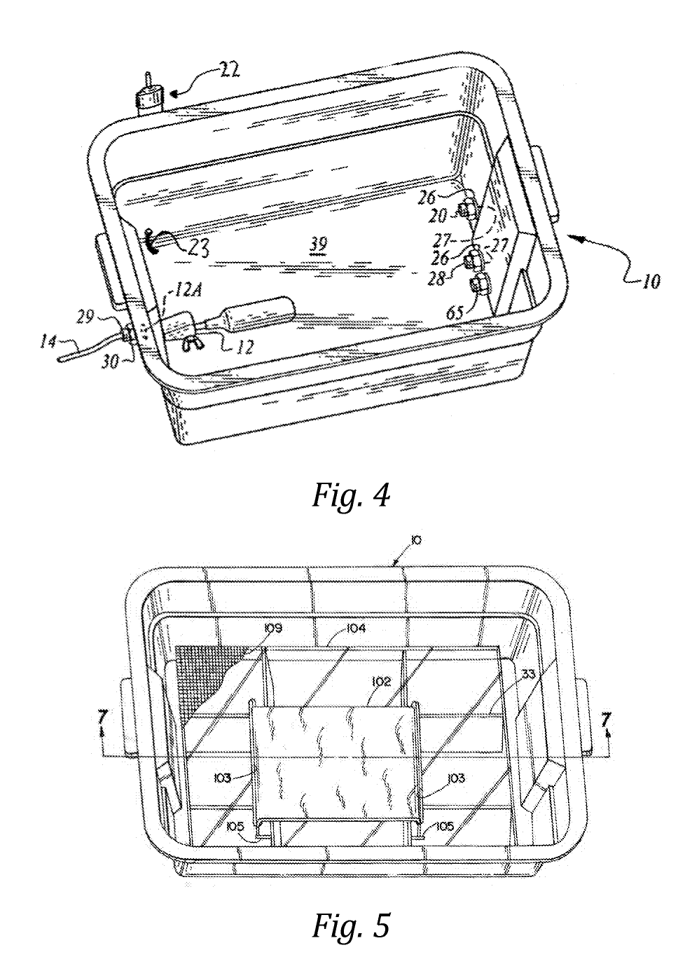

For purposes of clarity, this application will initially cover the components of the first container, as shown on FIGS. 3, 4, 5 and 6. Turning first to FIG. 3, a cutaway view of a fully assembled first container 10 is depicted. FIG. 5 similarly shows a fully assembled first container, but from a more top-oriented perspective. With these figures in mind, FIG. 4 shows said first container 10 with various upper components removed for clarity.

Here, a first container 10 is depicted, the first container 10 comprising a chamber 39 for water retention and a water supply hose 14 attached to either a reservoir or other suitable water source. Water supply hose 14 may be ¼″ diameter line and terminates into a nipple 29 on the outside of container 10, the nipple being sized accordingly to accept supply hose 14. Nipple 29 is retained in position by nut 30, preferably made from polyoxymethylene plastic or other suitable thermoplastic exhibiting high stiffness and low friction. In an alternative embodiment an optional timer may be placed in line with supply hose 14 to limit the water flow into the first container according to a schedule determined by the user.

Nipple 29 is connected to a float valve 12, which in the exemplary embodiment shown in the figures herein is mounted on the outside of the container through an exit aperture 12A. Float valve 12 controls the input of incoming water into chamber 39. That is, it directs whether water is flowing through supply hose 14. Such float valves are readily available and their use and operation is well understood, in that at a preset point, as the water rises, the float (unlabeled) rises until the preset point at which the water supply is cut off to prevent further input of fluid, here water.

First container 10 further comprises two grommets, 26, seen on one interior end face of first container 10. These each overlay a throughbore 27, in one of which is a high water level controller 20, comprising an elbow that is rotatable within the throughbore for water level adjustment, the high water level control 20 is present to limit the maximum elevation of the water in the containers. As alluded to above, the water level among containers is consistent (as would be expected following the laws of physics) however that level may be adjusted either by adjustments to float valve 12 or high water controller 20. High water controller 20, and specifically its elbow portion, is also clearly visible on FIG. 2. Turning back to FIG. 4, tubular nipple 28 is in connection with one of said grommets 26. This provides the coupling device to which tubing can be attached and through which additional containers may be placed in fluid connection. Because in the preferred embodiment of the invention additional containers are in fluid relation to first container 10, high water level controller 20 serves all other containers by extension. Both the controller 20, and the nipple 28 may be formed from plastic parts available in the marketplace for use by drip system installers. The elevational placement of the high water level controller 20 must be below the high water level.

In an alternative embodiment the high water level controller 20 hole also serves as the water supply hose hole. In a separate alternative embodiment, the float valve may be attached directly to the support structure 33.

FIG. 4 also depicts an optional water level gauge 22 affixed to the side of container 10 by means commonly known in the art. The water level gauge includes a water level gauge hose 23 that runs through a sidewall of container 10, a cap (unlabeled) comprising a central opening through which projects a water-level gauge, such as a tube or rod. Hydrostatic forces cause fluid to move in and out of the portion of the water level gauge hose 23 that is disposed in said first container 10, thereby causing a bulb (unlabeled) floating within gauge 22 to rise. When installed in a water container chamber, the float rises and the gauge (such as a tube or rod) extends out the central opening in the cap. The gauge may carry indicia to give a measurement of the height of the water in the first container's chamber.

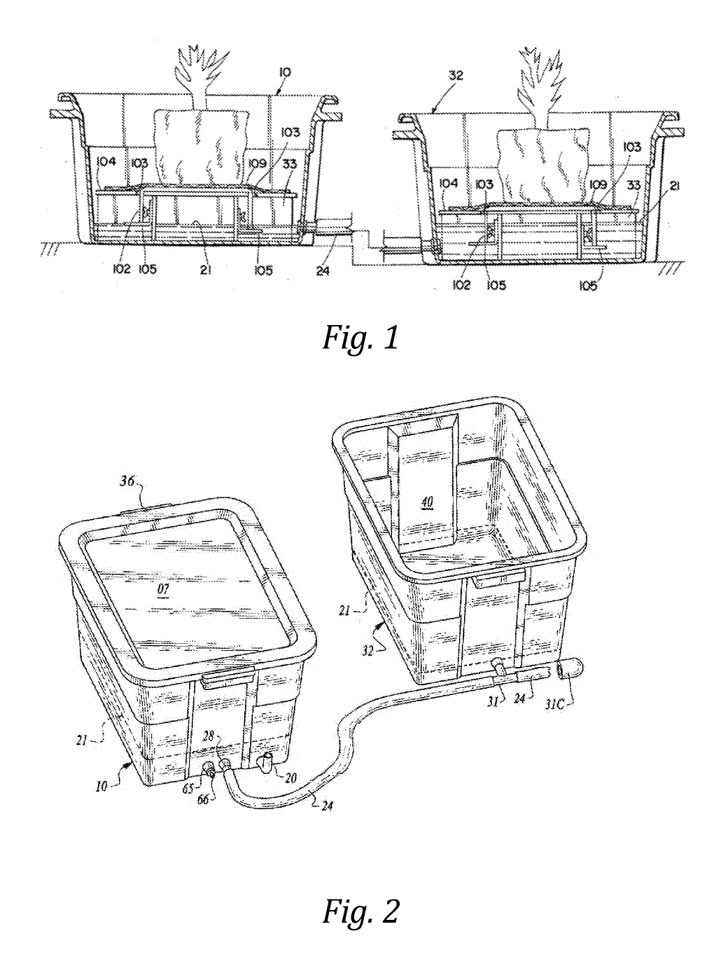

Returning to FIG. 2, an additional container 32 is shown adjacent to said first container 10. Tubing 24 fluidly connects the two containers which are at varying elevation, as more clearly shown by a brief review of FIG. 1. The tubing is attached to nipple 28 on one end and to tee 31, which may also function as an elbow with a cap 31C thereon, for use in the case where no further additional containers 32 with their interior chambers 40 are daisy chained together. If a second or additional containers 32 were to be attached, another segment of tubing 24 similar to that shown here would replace cap 31C and the additional container would be in fluid connection with all others. In this preferred embodiment, all of the additional containers 32 receive fluid from the single first container 10.

FIG. 2 also shows the exterior of the water level control chamber, referred to above as first container 10. Here lid 7 is shown in place with handles 36 directly thereunder. The high water level is shown as dashed line high water level 21. Were there no elevation difference between the two containers, the high water level 21 would be consistent between the two, and through adjustments to the wick height (described infra) the amount of water provided for each plant may be varied as the water level drops. For instance, if the wick height is lower for a plant in a first container relative to the wick height for a plant in a second container, the plant in the first container will remain in fluid connection with the water even once the water level falls below the wick height for the plant in the second container. In both containers, water contacts the wick (not shown in this figure) and be thusly drawn up by the plant. Controller 20 is visible on first container 10. As can be seen, there are no other openings in additional container 32 other than the fluid connection to other containers. While first container 10 comprises a third opening of a similar nature designated as opening 65, it is used only in the event different diameter tubing, smaller or larger, is to be utilized (not shown). Otherwise this opening remains closed off by a plug 66.

FIGS. 3, 5, and 6 most clearly show the wicking assemblage 101, disposed within a generic reservoir container. The wick 102 is threaded through two wick slits 103 on the platform 104. The wick slits 103 allow wick 102 to drop down in elevation until they are stopped by a horizontal surface on wick elevators 105 that are attached to a plant support structure having in this exemplary embodiment the shape #. Turning briefly to FIG. 1, platform 104, wick 102, and wick elevator 105 are shown in cross sectional view in a first container 10 and an additional container 32. Here it should be clear that the elevators 105 may be positioned such that the wick 102 is either above the water line or submerged below the high water level 21. This fact will be important, as the water line may vary from chamber to chamber when there is an elevational change from chamber to chamber such as when a series of chambers are fluidly connected on an incline. Wick 102 may comprise any fabric-like material that exhibits the ability to wick water, such as strips of felt, terry cloth, or wool.

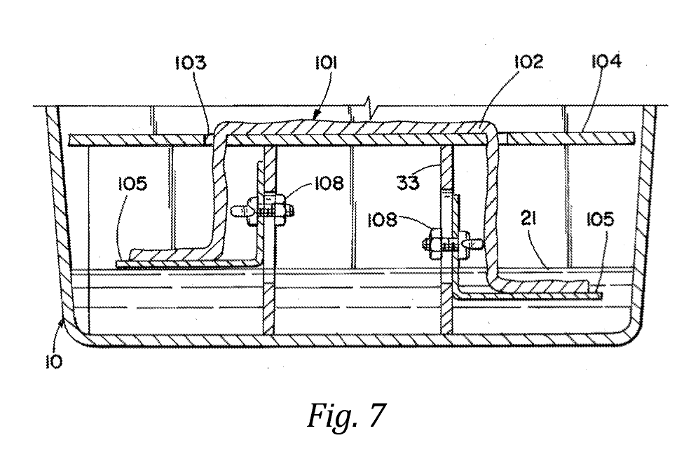

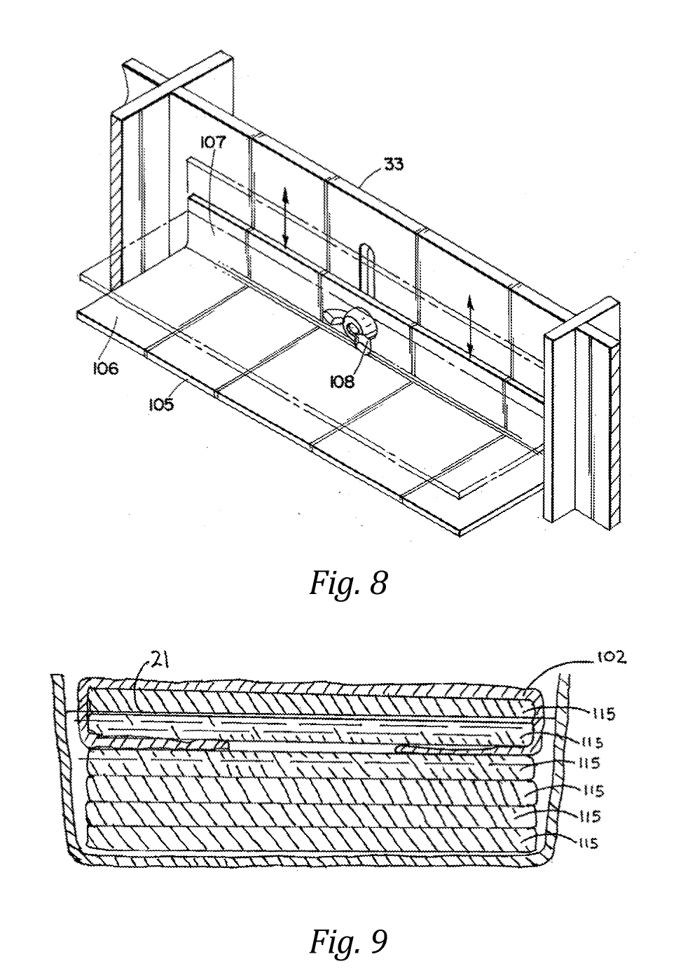

FIGS. 7 and 8 show detailed portions of the wicking assemblage 101. FIG. 7, a cross sectional view taken along cutline 7-7 in FIG. 5, shows the wick elevator 105, which attaches to support structure via a sliding screw 108. On the left side wick elevator 105 is above high water level 21 while on the right side wick elevator 105 is below high water level 21. Wick elevator 105 is shown in greater detail in FIG. 8, wherein it is shown to comprise a horizontal section 106 and a vertical section 107. Vertical section 107 is attached to a support structure via a sliding screw 108, which passes through both a hole in the vertical section 107 and through a vertically oriented slot (not labeled) in the support structure. This allows the wick elevator 105 to be raised or lowered relative to the support structure and also relative to a water surface.

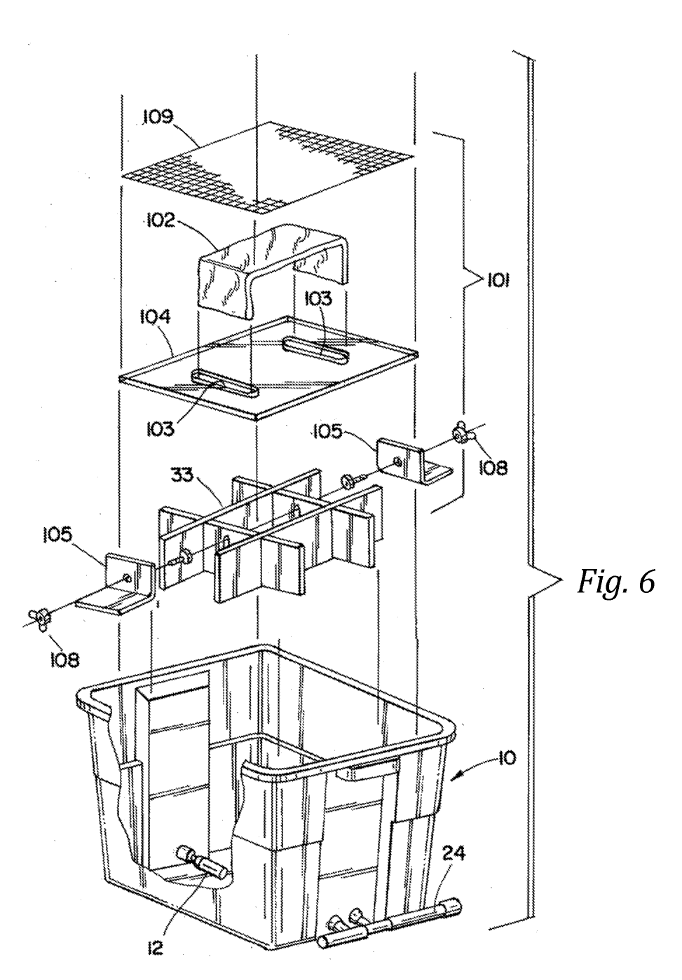

FIG. 6 clarifies the essential portions of the present invention through an exploded view in which all are visible. This discussion will start at the bottom of the figure and move upwards, describing the components one at a time such as where one would assemble the device for use. First container 10 is in fluid connection with water transfer tubing 24. Within first container 10 is nested a support structure 33 in this instance in the shape #. Support structure 33 comprises at least two wick elevators 105 to be secured at a user-determined height through a tightening of sliding screw 108. Resting on top of support structure 33 is platform 104, itself comprising wick slits 103 vertically aligned with said wick elevators 105. A wick 102 is positioned on top of the platform 104, the two ends of said wick 102 are threaded through the wick slits 103 such that the ends of said wick 102 drape down to and rest on the wick elevators 105 below. Between the two ends the wick 102 is pulled somewhat taught across the platform 104 as illustrated. On top of the platform and the wick is a dark potting mesh 109 such as a geotextile, landscape mesh or other medial protection sheet, which prevents light as well as the plant roots from entering the wicking assembly 101 below.

Finally, and not shown in this figure, it is on top of potting mesh 109 that a plant may be placed. The complete system in use is best shown in FIG. 1. Many elements from FIG. 6 are also present in FIG. 1, namely, platform 104 having wick slits 103 through which drapes wicks 102 until they rest on wick elevators 105 below. Moving along from left to right, four wick elevators 105 are visible. The first of which is adjusted to provide the wick 102 a position above the high water level 21, while the second through fourth wick elevators 105 are submerged. It should be readily apparent that the amount of wick to be submerged may be kept constant from plant-to-plant, even where the water level varies. For instance, by raising the wick elevators 105 in additional container 32, the user could position them to replicate the positions of wick elevators 105 in first container 10. Once in position, water through capillary action is drawn up the wick 102 by the potted plant, at which point it is transferred through potting mesh 109 and into the unlabelled plant container.

Plants may be placed directly on the potting mesh 109, or may be placed there within a separate pot made from erosion control type cloth and having a water permeable bottom so that moisture can be wicked upwardly. See the “Smart Pot” sold by High Caliper Growing out of Oklahoma City, Okla. If certain plants to be disposed for watering within the confines of this invention require less moisture than others, the wick may simply be raised by the adjustable wick support shelf so as to limit the amount of contact the wick has with the water.

While in the preferred embodiment of the invention, adjustable wick elevators 105 are the means by which wick 102 is controllably kept at the low water level, other means are available as well. For instance, in one alternative embodiment, shown in FIG. 9 depicting a cross section similar to that shown in FIG. 7, the entire support structure 33 has been replaced by a plurality of flat, stacked plates 115 such as plastic lattice. The number of plates to be stacked in the bottom of any given container is dependent on the height of the water in that container. As discussed above, the height of the water varies dependent on the vertical relation of the container with the first container. For instance, if one container is much lower than the first container, the water level in that container would be deeper. Thus, more plates would be necessary to ensure one or more wicks are not below the low water level and that one or more wicks are not so far below the high water level that portions of the dark potting mesh or even the plant are submerged. Thus, if the user desires to allow one inch of the wick to drape into the water, the user may stack plates until they are one inch below the water line. With the above sentences in mind, it should be noted that there are instances where it could be desirable for the wick to remain below the low water level and thus the plant would not experience any dry down period and, more commonly, there are instances where it would desirable for the wick to remain below the high water level such that the base of the plant container would be submerged during the high water period.

In this alternative embodiment the stacked flat plates 115 serve both as support structure and as wick elevator. Here, the stacked plates are stacked such that the topmost plate 115 is just above the high water line 21. The wick 102 is draped across the plate, down two opposing sides of the plates, and then is inserted between two of the stacked plates. Essentially, the wick 102 is wrapped around a number of the topmost-stacked plates 115. Varying the number of topmost-stacked plates around which the wick is wrapped adjusts the wick height relative to the surface of the water.

This alternative embodiment involving stacked plates may be used with or without a platform comprising wick passage slits as in the preferred embodiment. They are however, not necessary. Not shown in FIG. 9, similar dark potting mesh may be draped across the wick just as in the preferred embodiment. Finally, a plant may be placed on top of the potting mesh. The potting mesh as well as the textile pot for the plant is water permeable. Because these components are in contact with the wick, the plant through capillary action will draw water up the wick, through the mesh and into its root system.

### USING THE INVENTION

Once the invention is set up as described, automatic replenishment of water lost to evapotransporation can be carried out on a consistent basis. Much of the growing medium may remain near saturation and through periodic reintroduction of water utilizing float valve 12, the water level may remain fairly static at approximate the high water level. Alternatively by use of a water input control valve the growth medium can be allowed to go through wet and dry cycles, which is beneficial for many types of plants.

In order to provide equal moisture to each container's plants it is important to adjust the wick level of each container. This is accomplished by placing the containers in their desired location, fluidly connecting them, connecting the first container to a water source, opening the water input control valve, allowing the containers to fill to a level determined by the float valve 12, and then adjusting the wicks 102 using the wick elevators 105 such that each wick's lower portion is located a distance below the surface of the water in each container. In order to provide all plants with equal access to the water, the distance the wick's lower portion is beneath the water should be equal.

In the above described alternative embodiment, in order to provide equal moisture to each container's plants the same steps are followed as described immediately above for the preferred embodiment except that instead of adjusting the wicks using the wick elevators the user adjusts the wicks by varying the number of stacked plates around which the wick is wrapped.

Alternatively, the system may be adjusted to provide differing levels of moisture to each container by adjusting the wick levels. In order to provide less moisture to a given container the user would simply adjust the wick level to a higher location relative to the bottom of the container or the water surface, and visa versa if more moisture is desired. Similarly, in the alternative embodiment the user may place the ends of the wick between an increased or decreased number of plates.

While in a preferred embodiment nestable plastic tubs have been described, other materials and containers may be used without departing from the spirit of the invention. Materials such as hard plastic and stainless steel may be used, as well as containers made from breathable materials, but at a greater financial cost.

In a preferred embodiment a plurality of containers are used, although in practice the wicking action of even one container alone may provide benefits. In an exemplary instance where ten containers are used, even if the ground level is not level between containers, so long as the wick levels were adjusted to offset the change in ground height, each plant has access to a common pool of water with a common high water level and low water level.

One of the main benefits of the present invention is that it facilitates the control of alternating wet and dry cycles. It is beneficial to most plants to have wet (saturated) periods alternating with dry periods. The system achieves this through control over the water level in relation to the wicks. Once the containers have been filled to the high water level, the float valve shuts off the water, at this point, the water supply to the float valve can be shut off manually or by a timer. Water will move by capillary action from the common reservoir into the soil of a container until the soil reaches field capacity. As water is consumed (by the plant and lost due to evapotranspiration) it will continue to be wicked up from the reservoir, maintaining the soil at field capacity. The water level will lower to the low water level, which is the level where the wick is no longer in contact with the reservoir; the soil of that container will begin to dry down.

In one optional installation, each wick height is adjusted so that the distance from the wick to the water level is identical, even if there are ground elevational differences between containers. So long as the device was set up to provide each wick identical access to the water level, all plants are removed from fluid connection to the water simultaneously.

In another optional installation, the commencement of the dry down period for each container can be manipulated by raising or lowering the wick for each container in relation to each other wick and the water level. For instance, if one wick is placed at a position lower than all others, than that container would be in fluid connection to the reservoir even after the fluid connection to all others was broken.

Once the fluid connection to all containers and plants is broken, water may eventually need to be reintroduced to the system. The user can adjust the length of dry down time as necessary. Water may also be reintroduced to the system automatically through a timer. While it would be possible to simply leave the system at the high water level through an always-on connection that supplies water each time the float valve drops below a given mark, in a preferred embodiment the reservoir water is allowed to drain as much as possible before being replenished with fresh water. If left at a static high level the water will tend to become stagnant, thereby leading to foul smells, algae growth, potential mosquito problems, and even root rot problems.

In addition to the above benefits, the present system also prevents the occurrence of overly saturated soil and underwatering. Because, for the most part, water is supplied to the soil by means of capillary action the water content of the vast majority of the soil does not exceed the field capacity of the soil, i.e. the point where water no longer drains from the soil due to gravity. Underwatering is more likely to be avoided because of the reservoir access provided for each plant. To optimally meet the needs of a containered plant that requires a lot of water, such as a tomato plant, water must be supplied at least 3 to 4 times per day. A very reliable watering schedule is thus needed to prevent under or overwatering. Using the system described herein, the plant has access to the water reservoir as needed.

Although the invention has been shown and described with respect to certain embodiments, it is obvious that equivalent alterations and modifications will occur to others skilled in the art upon the reading and understanding of the specification. In particular, with regard to the various functions performed by the above-described components, the terms (including any reference to a “means”) used to describe such components are intended to correspond, unless otherwise indicated, to any component which performs the specified function of the described component (e.g., that is functionally equivalent) even though not structurally equivalent to the disclosed component which performs the functions in the herein exemplary embodiments of the invention. In addition, while a particular feature of the invention may have been disclosed with respect to only one embodiment, such feature may be combined with one or more other features of other embodiments as may be desired or advantageous for any given or particular application.

I claim:

1. A multiple plant watering container system comprising:
a) a primary container comprising:
i) a primary container plant support structure further comprising a horizontal barrier with at least one opening therethrough;
ii) water;
iii) a primary container water level below said primary container plant support structure;
iv) a primary container wick connecting said water with said primary container plant support structure and passing through said at least one opening; and
v) at least one portal in fluid connection with said water;
b) at least one secondary container comprising:
i) a secondary container plant support structure further comprising a horizontal barrier with at least one opening therethrough;
ii) a secondary container water level below said secondary container plant support structure;
iii) a secondary container wick connecting said water with said secondary container plant support structure and passing through said at least one opening; and
iv) a fluid connection to said primary container such that said water may freely flow between said containers; and
c) wherein said primary container is at a first elevation and said secondary container is at a second elevation.

2. The multiple plant watering container system according to claim 1 wherein:
a) a primary container water permeable wicking platform rests on said primary container plant support structure and is in contact with said primary container wick; and
b) a secondary container water permeable wicking platform rests on said secondary container plant support structure and is in contact with said secondary container wick.

3. The multiple plant watering container system according to claim 2 wherein:
a) a portion of said primary container wick rests below said primary container plant support structure on a primary container adjustable wick shelf; and
b) a portion of said secondary container wick rests below said secondary container plant support structure on a secondary container adjustable wick shelf.

4. The multiple plant watering container system according to claim 3 wherein:
a) said portion of said primary container wick rests below said primary container water level; and
b) said portion of said secondary container wick rests below said secondary container water level.

5. The multiple plant watering container system according to claim 4 wherein said first container further comprises a water input portal in fluid connection with an external water supply.

6. The multiple plant watering container system according to claim 3 wherein said primary container adjustable wick shelf is adjustable relative to a bottom of the primary container and wherein said secondary container adjustable wick shelf is adjustable relative to a bottom of the secondary container.

7. The multiple plant watering container system according to claim 6 wherein said first container further comprises a water input portal in fluid connection with an external water supply.

8. The multiple plant watering container system according to claim 2 wherein:
a) a portion of said primary container wick rests below said primary container water level and between two primary container flat plates; and
b) a portion of said secondary container wick rests below said secondary container water level and between two secondary container flat plates.

9. The multiple plant watering container system according to claim 8 wherein:
a) said portion of said primary container wick rests below said primary container water level; and
b) said portion of said secondary container wick rests below said secondary container water level.

10. The multiple plant watering container system according to claim 9 wherein said first container further comprises a water input portal in fluid connection with an external water supply.

11. A plant watering container system comprising at least one container, the plant watering container system comprising:
a) water having a water level;
b) a horizontal plant support structure comprising at least one opening therethrough;
c) a water permeable wicking platform resting on said support structure;
d) a wick connecting said water with said water permeable wicking platform wherein only a portion of said wick is beneath said water level, and wherein said portion has a size; and
e) an adjustment means for adjusting the size of said portion.

12. The plant watering container system according to claim 11 wherein said adjustment means comprises an adjustable wick shelf having an adjustable height relative to a bottom of said container.

13. The plant watering container system according to claim 11 wherein said adjustment means comprises a plurality of stacked flat plates and wherein said portion rests between two said plates.

14. The plant watering container system according to claim 11 further comprising a portal fluidly connecting said container with at least one other said container;

15. The plant watering container system according to claim 14 wherein said adjustment means comprises an adjustable wick shelf having an adjustable height relative to a bottom of said container.

16. The plant watering container system according to claim 14 wherein said adjustment means comprises a plurality of stacked flat plates and wherein said portion rests between two said plates.

17. A method of using a multiple plant watering container system comprising the steps of:
a) providing a primary container comprising:
i) a primary container plant support structure further comprising a horizontal barrier with at least one opening therethrough;
ii) water;
iii) a primary container water level below said primary container plant support structure;
iv) a primary container wick connecting said water with said primary container plant support structure and passing through said at least one opening; and
v) at least one portal in fluid connection with said water;
b) providing at least one secondary container comprising:
i) a secondary container plant support structure further comprising a horizontal barrier with at least one opening therethrough;
ii) a secondary container water level below said secondary container plant support structure;
iii) a secondary container wick connecting said water with said secondary container plant support structure and passing through said at least one opening; and
iv) a fluid connection to said primary container such that said water may freely flow between said containers.
c) placing said primary container at a first elevation and said secondary container at a second elevation; and
d) fluidly connecting said first and secondary containers via their fluid connection means.

18. The method of using a multiple plant watering container system according to claim 17, the method further comprising the steps of:
a) placing a portion of said primary container wick below said primary container plant support structure and on a primary container adjustable wick shelf; and
b) placing a portion of said secondary container wick below said secondary container plant support structure and on a secondary container adjustable wick shelf.

19. The method of using a multiple plant watering container system according to claim 18 wherein:
a) said portion of said primary container wick rests below said primary container water level; and
b) said portion of said secondary container wick rests below said secondary container water level.
